(19) United States
(12) Patent Application Publication
(10) Pub. No.: US 2008/0005745 A1
(43) Pub. Date: Jan. 3, 2008

(54) MANAGEMENT SERVER AND SERVER SYSTEM

(76) Inventors: Kimihide Kureya, Yokohama (JP); Yoshifumi Takamoto, Kokubunji (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/683,460

(22) Filed: Mar. 8, 2007

(30) Foreign Application Priority Data
Jun. 28, 2006 (JP) 2006-178252

(51) Int. Cl. G06F 9/46

(52) U.S. Cl. 718/106

(57) ABSTRACT

A management server for managing a plurality of servers dynamically selects, from among the plurality of servers, a second server which is not allocated, and which corresponds to a first server to execute a jobnet for batch processing, then the management server sets a server environment, in the selected second server, which is a server environment in the first server, executes each job forming a jobnet on the first server and the second server in which the server environment has been set respectively, and releases the second server when execution end notification for the jobnet is received from the first server and the second server respectively.

### CROSS-REFERENCE TO PRIOR APPLICATION

This application relates to and claims the benefit of priority from Japanese Patent Application number 2006-178252, filed on Jun. 28, 2006 the entire disclosure of which is incorporated herein by reference.

### BACKGROUND

The present invention relates to a server system and particularly relates to an open server system.

For example, there is a growing tendency to execute fixed tasks on open type server systems (referred to as openserver systems below) that in the past were executed on mainframe type server systems (referred to as mainframe server systems below), in order to lower costs.

Openserver systems can be expanded by increasing the number of openservers, however, each server (referred to as openservers below) that is a constituent component of the openserver system has characteristics that allow low-cost expansion in order to keep costs low. Thus openserver systems are applied to WEB server systems in which for example multiple demands (for example, multiple processing of transactions or multiple requests) are generated. Also, in WEB server systems the amount of processing for each request is small, the processing can be done in a short amount of time, the effects of downtime in the WEB server system are limited, the technology for recovery processing in established, and the like, thus there are no major problems associated the reliability of openserver systems.

However, when performing batch processing such as over-night batch processing in which the length of the processing time is many hours, not only is the processing time long but the volume of data to be processed is large, thus the effect of a fault on the server system is large. Also the confinements are strict as to when the processing is executed since normally batch processing must be finished by a predetermined time (for example, by a certain time in the morning of the next day).

Thus, when executing batch processing in openserver systems, it is necessary to increase the reliability (for example, the reliability of the hardware and software) of the openserver system. Two approaches are shown below to bring about high reliability in openserver systems.

(1) Japanese Unexamined Patent Application Publication No. 2006-11576 and Japanese Unexamined Patent Application Publication No. 2002-244879 are given as examples of a method in which hardware such as processors and buses are multiplexed.

(2) Japanese Unexamined Patent Application Publication No. 2004-80240 and Japanese Unexamined Patent Application Publication No. H8-161188 are given as examples of a method in which a plurality of servers are provided and requests are issued to the plurality of servers.

In the first method described above there is a need to develop specialized hardware to achieve multiplexing. Thus higher costs arise.

On the other hand, in the second method mentioned above high costs can be suppressed, however, actual operation is cumbersome due to the request issuing side seeing a plurality of servers.

### SUMMARY

Accordingly, an object of the present invention is to offer a low-cost server system in which the operation of the server system is reliable for performing batch processing and in which the operation is not cumbersome.

The management server according to the present invention is a management server for a server system that comprises a plurality of servers and the management server, which is for managing the plurality of servers. The management server comprises a second server selection unit, a server environment setting unit, a jobnet execution unit and a server release unit. The second server selection unit selects, when the jobnet which is formed from one or more jobs for the batch processing is executed, a second server that is not allocated, from among the plurality of servers, which includes a first server that executes the jobnet. The server environment setting unit sets a server environment, in the selected second server, which is a server environment of the first server. The jobnet execution unit executes each job that forms the jobnet in the first server and the second server in which the server environment has been set respectively. The server release unit releases the second server when execution end notification is received from the first and second servers, respectively. In the release of the second server the set server environment is, for example, discarded by the second server.

In a first embodiment the management server further comprises a server management storage unit (for example, a memory area) for storing server management information including information relating to each server resource and to an allocation condition of each server, and a job definition storage unit (for example, a memory area) for storing job definition information including information relating to resources necessary for executing the jobnet. The second server selection unit selects a server that is not allocated and that has the resources necessary for executing the jobnet, by referring to the server management information and the job definition information.

In a second embodiment the job definition information in the first embodiment also includes a degree of multiplexing for the jobnet, and the second server selection unit selects the same number of servers to be second servers as the degree of multiplexing.

In a third embodiment, the first and the second servers are not activated when the server environment is set, and the server environment includes an execution environment for the jobnet.

The server environment setting unit activates the second server and then sets an execution environment, in the second server, which differs from an execution environment which has been set in the second server, this execution environment being the same as an execution environment in the first server, after which the server environment setting unit activates the first server.

In a fourth embodiment, the plurality of servers and the management server in the third embodiment are connected to a communication network having Internet protocol, and the execution environment is an IP address.

In a fifth embodiment, the storage system connected to the plurality of servers and to the management server to allow communication is included in the server system in the third embodiment. The storage system comprises a plurality of storage devices and a controller, and the plurality of storage devices include a first storage device for storing the server environment of the first server. The server setting environment unit causes the controller to copy the server environment in the first storage device to another storage device among the plurality of storage devices, connects the other storage device to the second server, activates the second server after the copy operation is completed, and thus induces the second server to read the server environment from the other storage device.

In a sixth embodiment, the jobnet execution unit continues to execute the jobnet, with the second server acting in place of the first server, when the jobnet execution unit receives notification of a failure from a first server in which the failure is detected when a requested job is executed.

In a seventh embodiment, the management server further comprises a job definition storage unit for storing job definition information, which includes information relating to the structure of the jobnet. The jobnet execution unit receives a normal ending notification for a job from a server which is a request destination of the job, discerns that the job has ended normally from the normal ending notification, and in the case that the jobnet execution unit receives a failure notification, from a server which is a request destination of a job, that a failure is detected while executing the job on the basis of whether the jobnet execution unit has received normal ending notification from another server which is a request destination of the job and on the basis the job definition information, the jobnet execution unit produces and displays a GUI inquiry, to an administrator, which shows that a failure is detected in the server from which the failure notification and the condition of the processing of the job in the other server which is a request destination of the job in accompany with the jobnet structure, and which inquires as to whether to continue or abort the job, and when the administrator chooses to continue, the jobnet execution unit continues the job.

In an eighth embodiment, the first server is set as an original server. The second server is set as a clone of the original server.

Each unit is achieved from hardware (for example, a circuit), a computer program, or a combination of the two (for example, one or a plurality of CPU that read computer programs for program execution). Each computer program can be read from a storage resource (for example, memory) comprised in the computer. The storage resource can be installed with a storage medium such as a CD-ROM or a DVD (Digital Versatile Disk), or can be downloaded via a communication network such as the Internet or a LAN.

### BRIEF DESCRIPTION OF THE DRAWINGS

FIG. 1 is a drawing showing a structural example of a computer system relating to an embodiment of the present invention;

FIG. 2 shows a structural example of a management server 101;

FIG. 3 shows a structural example of a server 105;

FIG. 4 shows a structural example of a storage system 109;

FIG. 5 shows an example that explains a host group function;

FIG. 6 shows an example of settings in the host group;

FIG. 7 shows a portion of the process of generating a clone server;

FIG. 8 shows the other portion of the process of generating a clone server;

FIG. 9 is a conceptual view of a job definition table 121;

FIG. 10 is an explanatory view of the basic concept when issuing and executing a jobnet;

FIG. 11 shows a structural example of the job definition table 121;

FIG. 12 shows a structural example of a server management table;

FIG. 13 shows a structural example of a job management table 125;

FIG. 14 shows a structural example of a storage management table 127;

FIG. 15 shows an example of the flow of the processing performed by a job execution management program 113;

FIG. 16 shows the condition of interchange between the job execution management program 113 and a system multiplexing program 117;

FIG. 17 shows an example of the flow of the processing performed by the system multiplexing program 117;

FIG. 18 shows an example of the flow of the processing performed by a job execution program 119;

FIG. 19 shows an example of the flow of the processing performed by a job execution agent 143; and

FIG. 20 shows an example of an execution state GUI.

### DESCRIPTION OF THE PREFERRED EMBODIMENTS

An explanation will be given below of an embodiment of the present invention. First an explanation will be given of a general outline of the embodiment.

The embodiment comprises a plurality of servers that execute jobs, which form a jobnet (a group of jobs formed from a plurality of jobs) in which batch processing is performed. The management server dynamically selects from the plurality of servers a server to act as a clone of an original server, which executes the jobnet, and activates the selected clone server and the original server, respectively. The management server releases at least the clone server if the management server receives notification of the job being ended from two or more servers. Also, the management server shows an administrator in which job and in which server a fault has occurred and in which other server processing of the job can be continued, and displays a GUI to inquire to the administrator whether to continue a job or whether to abort, when the management server receives a notification of a fault from the server executing the job. The management server determines whether to continue the job or to abort the job in accordance with the response to this inquiry.

A detailed explanation of the present embodiment will be given below. Note that the present embodiment does not limit the present invention.

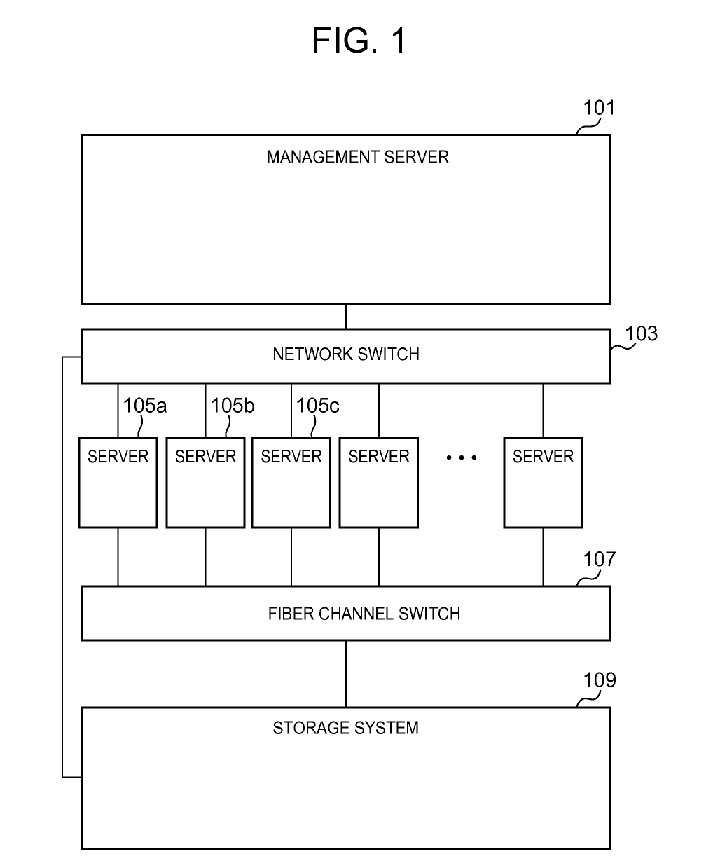

FIG. 1 is a drawing showing a structural example of a computer system relating to an embodiment of the present invention. Note that in the explanation below, identical elements are designated with the same number (for example,

105), and when distinguishing between them the elements are designated with a number and a letter (for example, 105a).

In this computer system, a management server 101, a plurality of servers 105, and a storage system 109 are connected to a network switch 103, and the plurality of servers 105 and the storage system 109 are connected to a fiber channel switch 107. The network switch 103 is, for example, a structural element of a communication network (for example, a LAN (Local Area Network)) using Internet protocol, and the fiber channel switch 107 is for example, a structural element of a SAN (Structural Area Network). Each switch 103 and 107 may be the same type of switch.

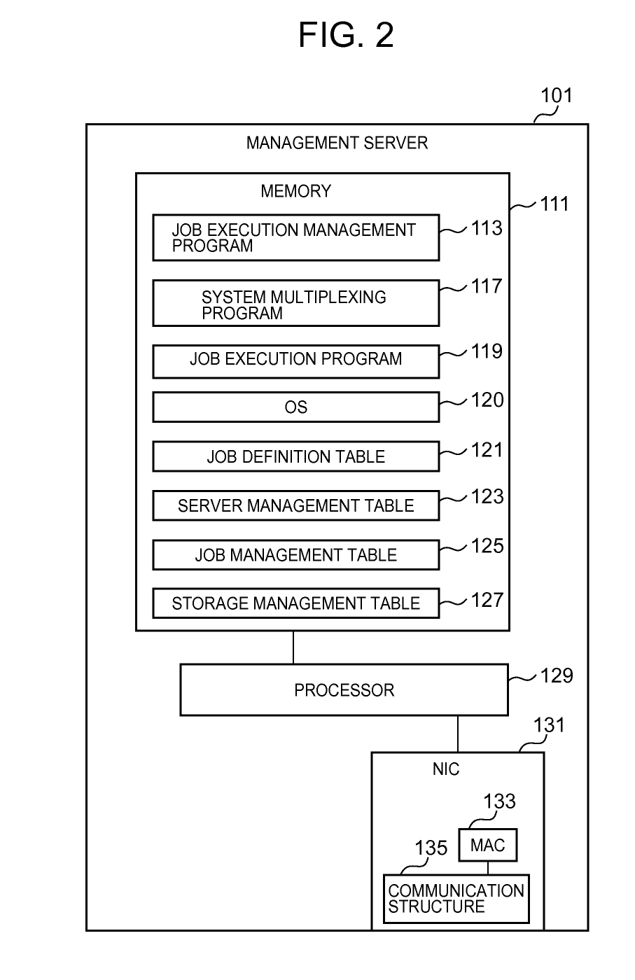

FIG. 2 shows a structural example of the management server 101.

The management server 101 is a type of computer and manages the jobs and the servers. The management server 101 comprises an NIC (Network Interface Card) 131, memory 111 (may also be a storage resource of another type) and a processor (for example, a CPU) 129.

The NIC 131 comprises a MAC (Media Access Control) address memory area 133, a structure for controlling communication (referred to as communication structure below) 135, and the like. Communication between the NIC 131 and a job execution management server 105 is via an NIC 153. Another type of communication interface device may be used instead of the NIC 131 according to the type of network employed for communication with the servers 105.

Computer programs executed in the processor 129, and information that is referred to when the computer programs are executed, and the like are stored in the memory 111. More specifically, for example, a computer program for managing the execution of jobs (referred to as the job execution management program below) 113, a program for dynamically multiplexing servers (referred to as the system multiplexing program below) 117, a program for commanding the jobs to be executed (referred to as the job execution program below) 119, and an operating system (OS) 120 (each program 113, 115, 117 and 119 operate through the OS 120) are stored in the memory 111. Also, for example, a table showing job definitions (referred to as the job definition table below) 121, a table for managing the servers (referred to as the server management table below) 123, a table for managing jobs (referred to as the job management table below) 125, and a table for managing storage (referred to as the storage management table below) 127 are also stored in the memory 111.

Descriptions of each type of program and information will be given as appropriate below. Also, when the computer program is the subject of a sentence, processing is actually performed by the processor that executes that computer program.

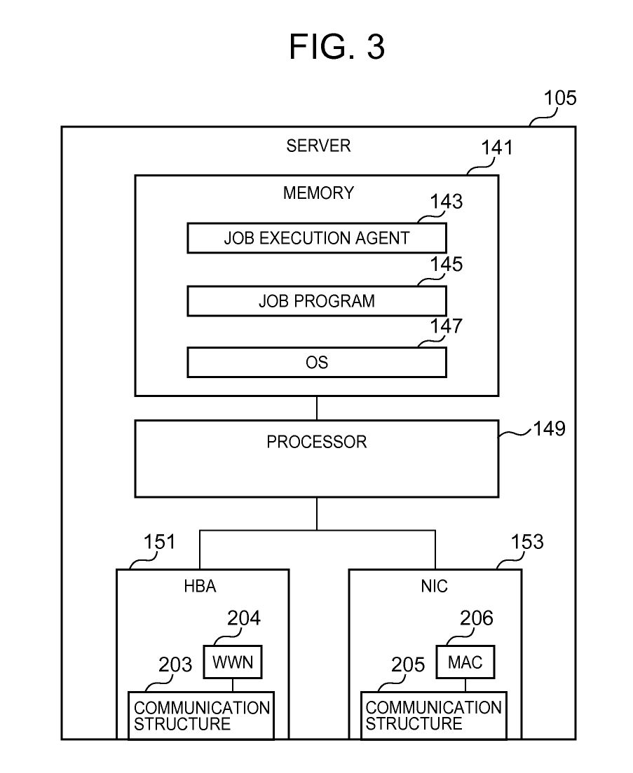

FIG. 3 is a structural example of the server 105.

The server 105 is a type of computer, and is a candidate for being the server that executes a job. The server 105 comprises the NIC 153, a HBA (Host Bus Adapter) 151, memory 141 (may also be a storage resource of another type), and a processor (for example a CPU) 149.

The NIC 153 comprises for example a MAC address storage area 206, a communication structure 205, or the like. Communication with the management server 101 is performed via the NIC 153. Another type of communication interface device may be used instead of the NIC 153 according to the type of network employed for communication with the job execution management server 105.

The HBA 151 comprises for example a WWN (World Wide Name) storage area 204, a communication structure 203, or the like. Reading and writing of data to and from the storage system 109 is via the HBA 151. Another type of communication interface device may be used instead of the HBA 151 according to the type of network employed for communication with the storage system 109.

For example, computer programs executed in the processor 149 are stored in the memory 141. More specifically, for example, a computer program for executing a job (referred to as the job program below) 145, a computer program for receiving a command to execute a job (referred to as the job execution agent below) 143, and an OS 147 (each program 143 and 145 operate through the OS 147) are stored in the memory 141. A portion of or all of these computer programs may be stored in the memory 141 in advance, however, in the present embodiment, all of these computer programs are obtained dynamically from the storage system 109, and are deleted from the memory 141. More specifically, for example, these computer programs are read from the storage system 109 and stored in the memory 141 when they are necessary for executing a job, and are deleted from the memory 141 when they are not needed (for example, in the case in which the execution of a job is ended).

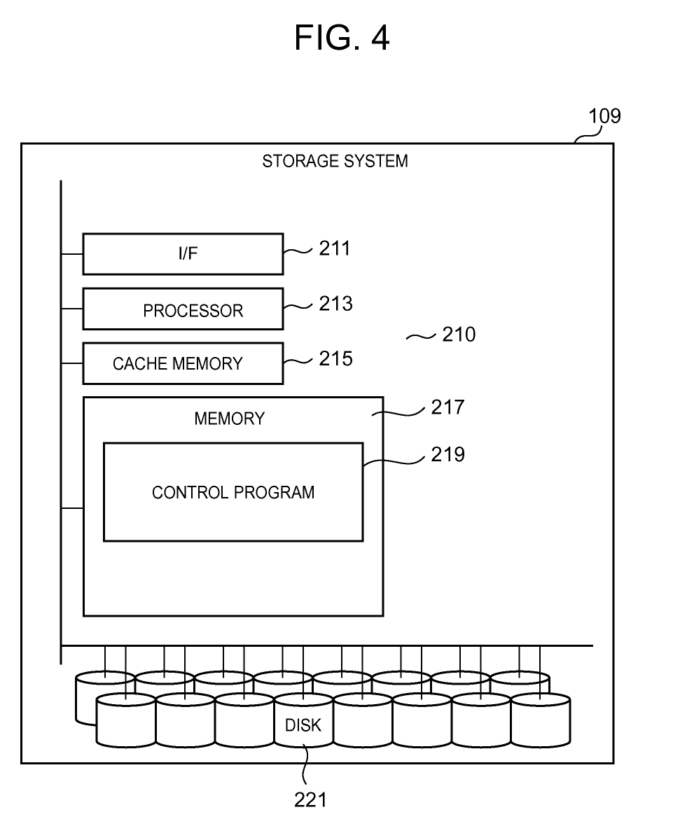

FIG. 4 shows a structural example of the storage system 109.

The storage system 109 comprises a plurality of disk devices 221 and a controller 210, which is connected to the disk devices 221. The controller 210 has for example an I/F 211 connected with an internal bus (an interface for the network switch 103 or an interface for the fiber channel switch 107), a processor (for example, a CPU) 213, cache memory 215, and memory 217. A computer program for controlling the storage system 109 (referred to as the control program below) 219 is stored in the memory 217 and is executed by the processor 213. Note that the disk devices 221 may be for example, hard disk drives, and in the storage system 109 a RAID (Redundant Array of Independent (or Inexpensive) Disks) structure may be employed for the plurality of disk devices. Also, another type of storage device (for example, flash memory) may be employed instead of the disk devices 221. The memory 217 and the cache memory 215 may also be integrated.

The control program 219 stores received data temporarily in the cache memory 215 when the storage system 109 receives write requests or data from the servers 105, and then the control program 219 reads that data from the cache memory 215 and writes that data to the disk device 221 that is the access destination according to the write request. When, the storage system 109 receives a read request from the servers 105, the control program 219 reads data from the disk device 221 that is the access destination according to the read request, and stores the data temporarily in the cache memory 215, then the data is read from the cache memory 215 and transmitted to the servers 105.

The storage system 109 has a plurality of virtual LUs and a plurality of physical LUs. The LUs are logical volumes or logical storage devices called logical units. The virtual LUs are provided as higher-level devices (the servers 105 in the present embodiment) in the storage system 109, and corresponded the physical LUs. The physical LUs are set using storage resources provided by the disk devices 221.

The storage system 109 has a security function called a “host group function” in the present embodiment. In the case in that two or more physical LUs (or two or more virtual LUs that are corresponded to the physical LUs) are corresponded to a communication port connected to the fiber channel switch 103, and communication is performed with a plurality of servers 105 via the communication port, the host group function acts so that in each server 105 only one allocated fixed physical LU among the two or more physical LUs can be accessed. A host group can thus be formed with a server 105 and a virtual and physical LU that is allocated to this server 105.

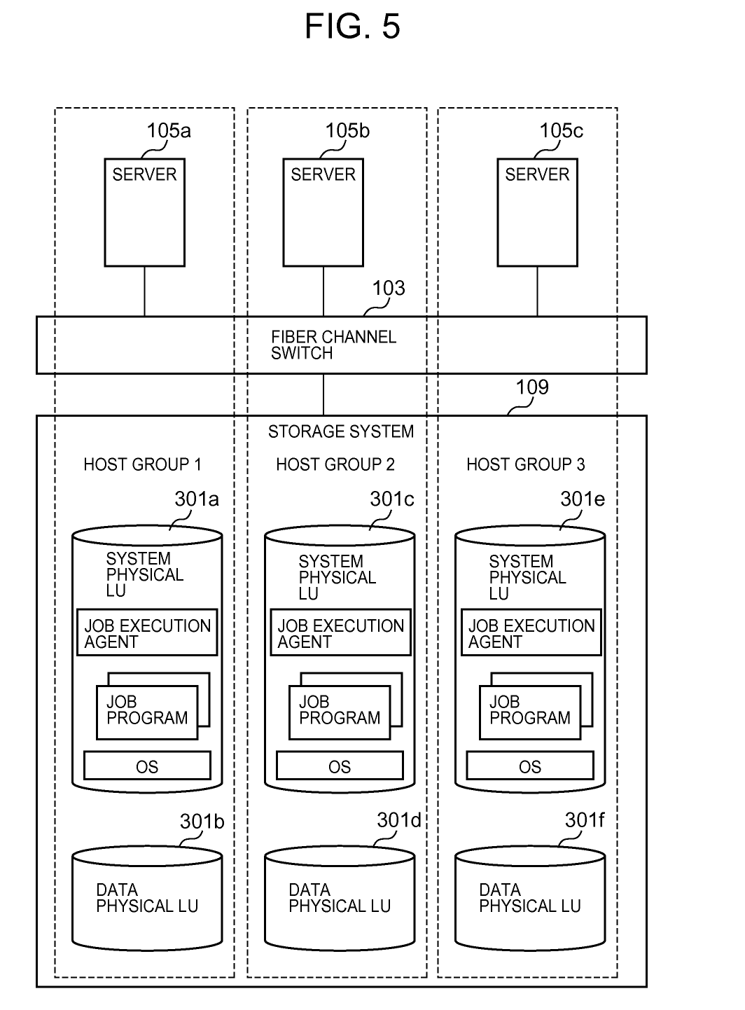

FIG. 5 shows an example that explains the host group function.

For example, to form a plurality of physical LUs in the storage system 109, two or more system physical LUs 301a, 301c and 301e, and two or more data physical LUs 301b, 301d and 301f are provided. A system physical LU is a physical LU in which the server environment of the server 105 (for example, the plurality of computer programs, the execution environment (for example, an IP address), or the like) is stored. A data physical LU is a physical LU in which data accessed by the server 105, through executing a job in the server environment, (data that is read or written) is stored.

In FIG. 5 the host group function sets three host groups. In host group 1, physical LUs 301a and 301b are allocated to the server 105a. In host group 2, physical LUs 301c and 301d are allocated to a server 105b. In host group 3, physical LUs 301e and 301f are allocated to a server 105c. In this manner the storage system 109 permits the server 105a to access the physical LUs 301a and 301b in the host group 1 which belongs to the server 105a, and denies the server 105a access to the physical LUs in other host groups 2 and 3.

Setting of the host groups can be performed from the computer (referred to as the maintenance terminal below) connected to the controller 210 of the storage system 109.

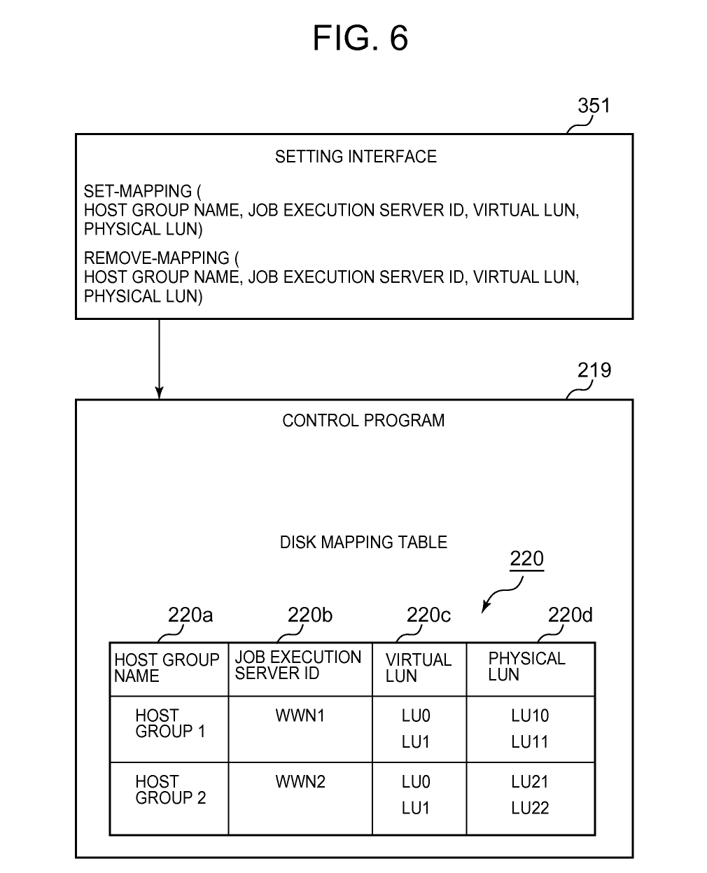

FIG. 6 shows an example of setting a host group.

For example, the system multiplexing program 117 is executed to issue commands, which are supported by an interface (referred to as the setting interface below) 351, to the control program 219, and in this manner setting and removing of host groups is dynamically performed.

There are two types of supported commands, a set-mapping command for adding a new host group, and a remove-mapping command for removing a host group.

The system multiplexing program 117 uses the set-mapping command to input information relating to the host group to be set when a new host group is set. In this manner the control program 219 stores, in accordance with the set-mapping command, the input information in a disk mapping table 220. The disk mapping table 220 is information maintained by the control program 219, and has a column 220a in which host group names are written, a column 220b in which server IDs (for example, WWN) are written, a column 220c in which virtual LUNs are written, and a column 220d in which physical LUNs are written. A host group name, server ID, virtual LUN, and physical LUN are recorded for each host group. More specifically, the group name, server ID, virtual LUN, and physical LUN make up the information relating to a host group. An LUN is a number for distinguishing between LUs (another type of code besides numbers may also be employed).

On the other hand, the system multiplexing program 117 uses the remove-mapping command to input information relating to the host group to be removed when a host group is removed. In this manner the control program 219, in accordance with the remove-mapping command, removes the input information from the disk map table 220.

In this embodiment, a clone (referred to as a clone server below) can be dynamically generated for the server 105 that executes a jobnet, and that clone server can be dynamically released, and the like. Generating a clone server involves dynamically setting the server environment of the original server in another server 105, and releasing a clone server involves nullifying the set server environment in the clone server (the other server) 105.

In the present embodiment the term server environment can indicate both a computer program group for executing a jobnet and the corresponding execution environment. The execution environment is an IP address. The computer program group, for example, may be transmitted to the server 105 from the computer or the storage system, but in the present embodiment, the server 105 that was selected as a clone reads the computer program group from the system physical LU 301.

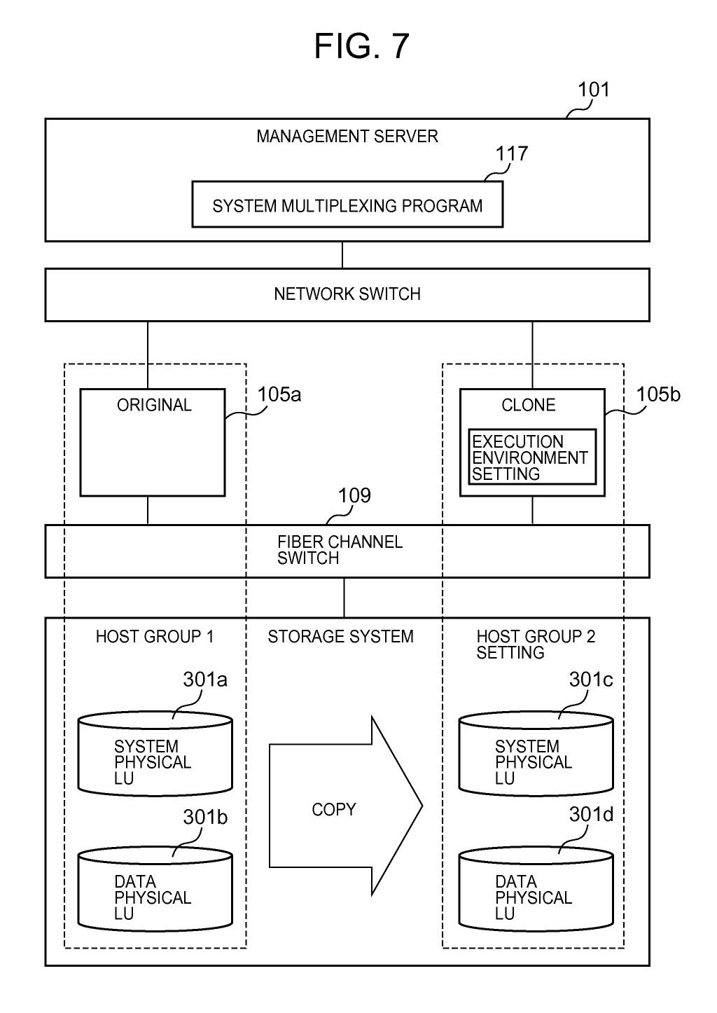

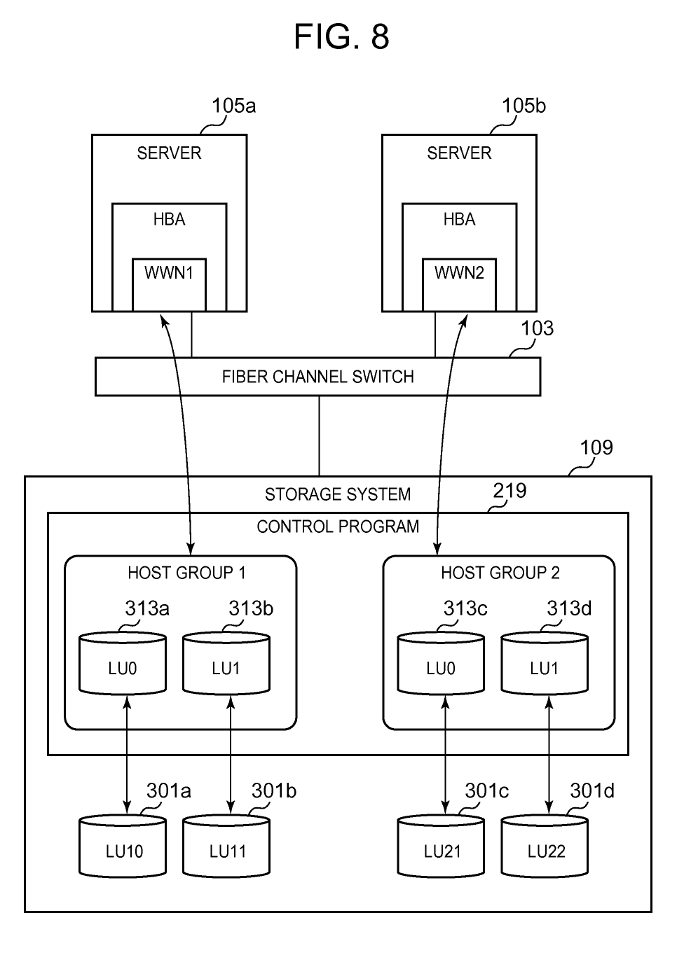

An explanation will be given below of an outline of the process of generating a clone server with reference to FIGS. 7 and 8.

FIG. 7 shows one portion of the process used when generating a clone server. FIG. 8 shows the remaining portion thereof. Note that the original server is termed server 105a and the clone server is termed server 105b in the explanation below.

If the original server 105a is in operation when the clone server is to be generated, the system multiplexing program 117 for example performs control so that writing is not performed to the virtual LU (referred to as the data virtual LU below) 313b, which is associated with the data physical LU 301b in the host group 1 to which the original server 105a belongs. More specifically, for example, the system multiplexing program 117 brings the original server to a static state (for example, the system multiplexing program 117 denies any writing to the data virtual LU 313b), or the system multiplexing program 117 shuts down the original server 105a (for example, the system multiplexing program 117 turns off power).

The system multiplexing program 117, as shown in FIG. 7, specifies the system physical LU 301a and the data physical LU 301b in the host group 1 to which the original server 105a belongs. Then the system multiplexing program 117 selects from among the plurality of other physical LUs, a physical LU 301c, having the same storage volume as the specified system physical LU 301a, the physical LU 301c being an unused physical LU. Then the system multiplexing program 117 copies the server environment of the system physical LU 301a specified by the control program 219, to the selected physical LU 301c. Also, the system multiplexing program 117 selects from among the plurality of other physical LUs, a physical LU 301d, having the same storage volume as the specified system physical LU 301b, the physical LU 301d being an unused physical LU. Then the system multiplexing program 117 copies the data group of the system physical LU 301b specified by the control program 219, to the selected physical LU 301d. After the copy operation is ended the result will be for example like the host group 2 in FIG. 5.

Next the system multiplexing program 117 selects a server 105b as the clone server from among the unused servers 105 other than the original server 105a. Then the system multiplexing program 117 dynamically sets host group information that includes an ID for the selected unused server 105b, a physical LUN for the system physical LU 301c, a virtual LUN (referred to as the system virtual LUN below) for a virtual LU (referred to as the system virtual LU below) 313c which is associated the system physical LU 301c, a physical LUN for the data physical LU 301d, and a virtual LUN (referred to as the data virtual LUN below) for a data virtual LU 313d which is a virtual LU associated with the data physical LU 301d. Then the system multiplexing program 117 issues an activation command to the selected unused server 105b, and notifies the server 105b of the set system virtual LUN and data virtual LUN. In this manner, as shown in FIG. 8, the server 105b is activated in response to the activation command, an then the server 105b issues a read command with the control program 219 to the notified system virtual LUN. The control program 219 specifies a system physical LUN that is associated with the system virtual LUN in which the read command is indicated, specifies the system physical LU 301c from the specified system physical LUN, reads the server environment from the system physical LU 301c, and transmits the read server environment to the server 105b. As a result, the transmitted server environment is set in the server 105b. In other words the server 105b becomes a clone of the original server 105a.

At this point the execution environment of the server 105b, immediately after the server environment is set, is the same as the execution environment of the original server 105a. Thus there is a possibility of an error occurring when the original server 105a is activated. As shown in FIG. 7, the system multiplexing program 117 sets an execution environment that differs (more specifically, an IP address that differs from that of the original server 105a) from the momentarily set execution environment in the clone server 105b in order to solve this problem.

The generation of the clone server is now complete through the series of processing described above, Next an explanation will be given of the information maintained in the management server 101.

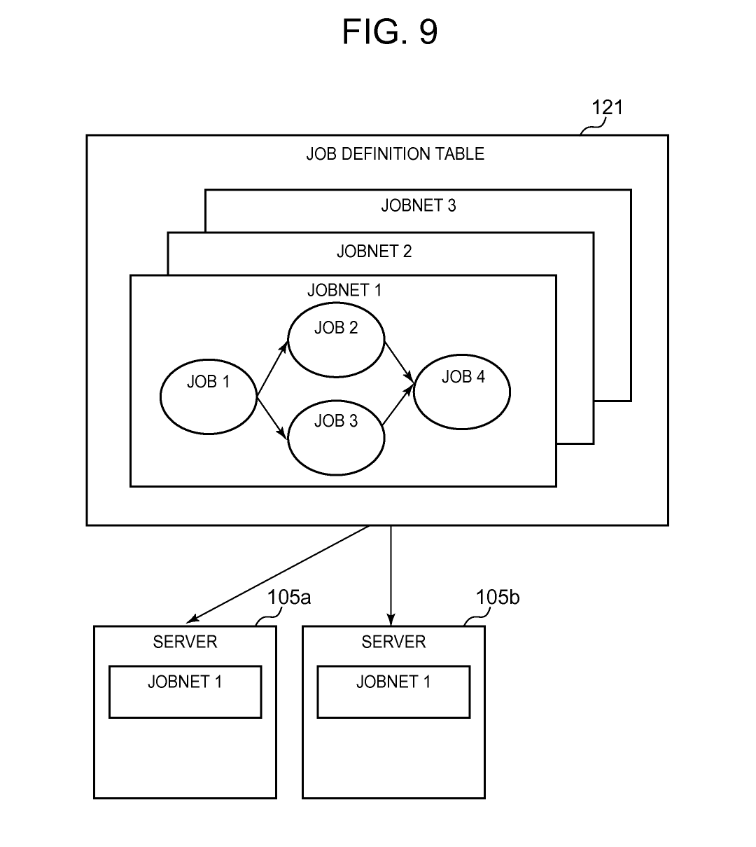

FIG. 9 is a conceptual view of a job definition table 121.

The job definition table 121 indicates information relating to each of one or more jobnets. The information relating to the jobnets is, for example, on how many clone servers is the jobnet to be executed on (the degree of multiplexing), how many jobs the jobnet has and at what timing the jobs are to be executed, or the like. The degree of multiplexing is a higher value for jobnets that require a higher degree of reliability. In the example in FIG. 9, a jobnet 1 is executed on one clone server (in other words the degree of multiplexing is one and there are two servers, the original and the clone), there are four jobs 1 to 4 in the jobnet 1, job 1 is executed first, then jobs 2 and 3 are executed in parallel and finally job 4 is executed.

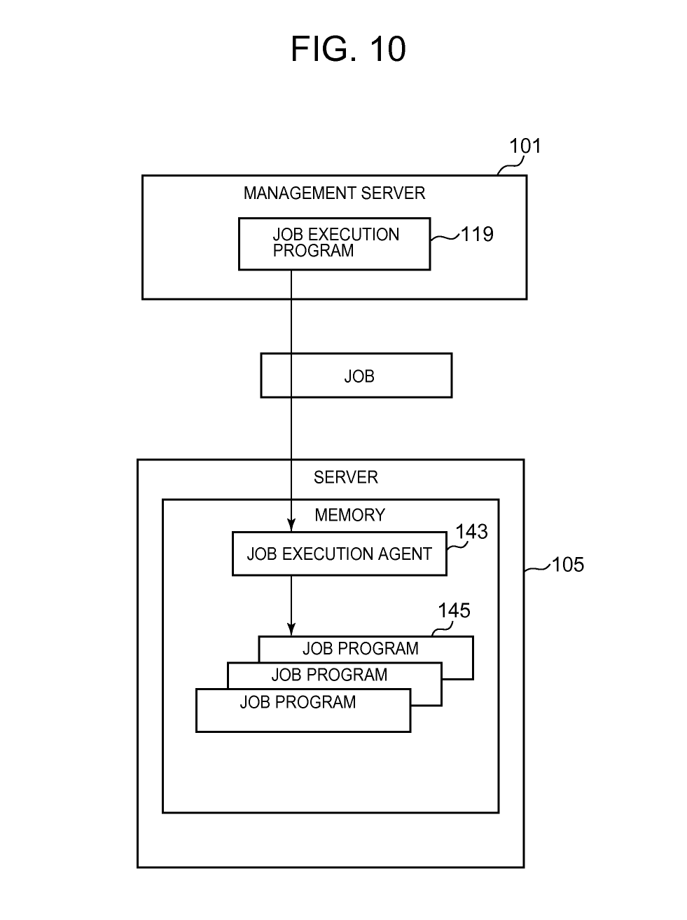

For comparison, each of the jobs that form a jobnet are sent by the job execution program 119 of the management server 101 to the server 105 via the network switch 103, as shown in FIG. 10. The job execution agent 143 in the server 105 receives a job and allocates that job to the job program 145 that will execute that job. The job program 145 then executes the allocated job.

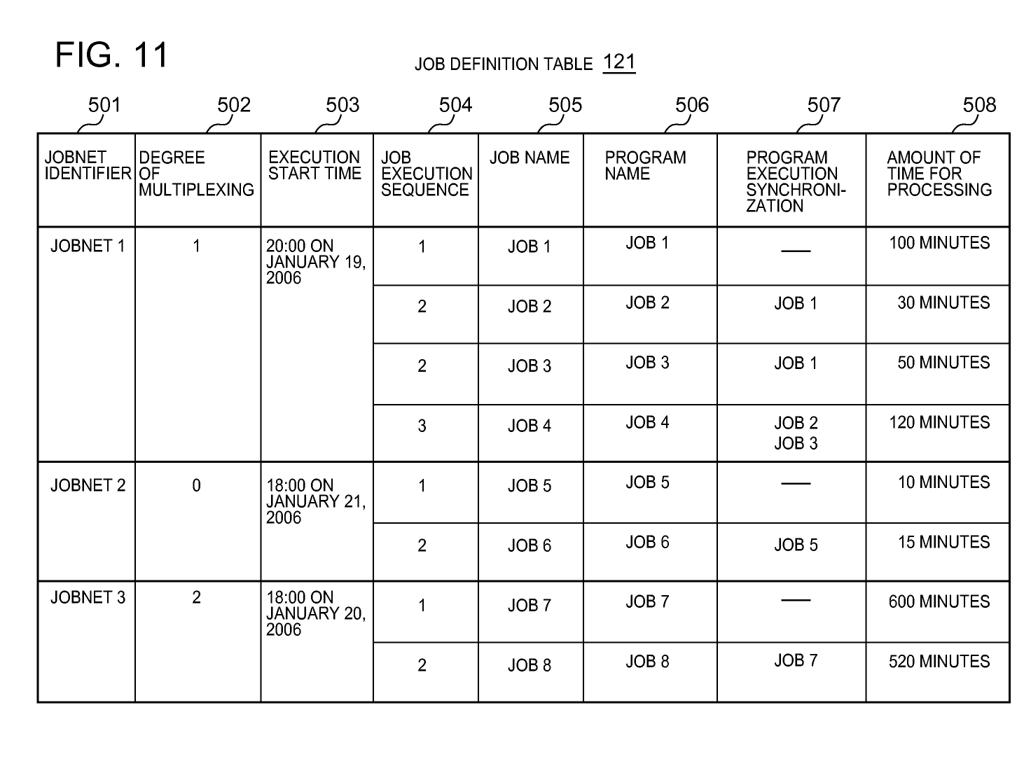

FIG. 11 shows a structural example of the job definition table 121.

The job definition table 121 has a column 501 in which a jobnet identifier (for example, a name) is written, a column 502 in which a degree of multiplexing (the number of generated clone servers) is written, a column 503 in which an execution start time is written, and columns in which information relating to jobs (referred to as job information below) is written. For one jobnet a jobnet ID, a degree of multiplexing, an execution start time and job information are written.

The columns in which the job information is written define what type of plurality of jobs form the jobnet, what timing at which to execute the plurality of jobs, and what time limit within which each job should be executed. More specifically, the columns in which the job information is written comprise a column 504 in which a job execution sequence is written for each of the plurality of jobs that form a jobnet, a column 505 in which the job names (may be another type of ID) are written, a column 506 in which the job program that will execute a job is written, a column 507 in which program execution synchronization is written and a column 508 in which the length of the job processing time is written. The program execution synchronization could also be called the execution start timing of the job. For example, the program execution synchronization of job 2 is “job 1”, meaning that the execution of job 2 starts synchronized to the completion of job 1.

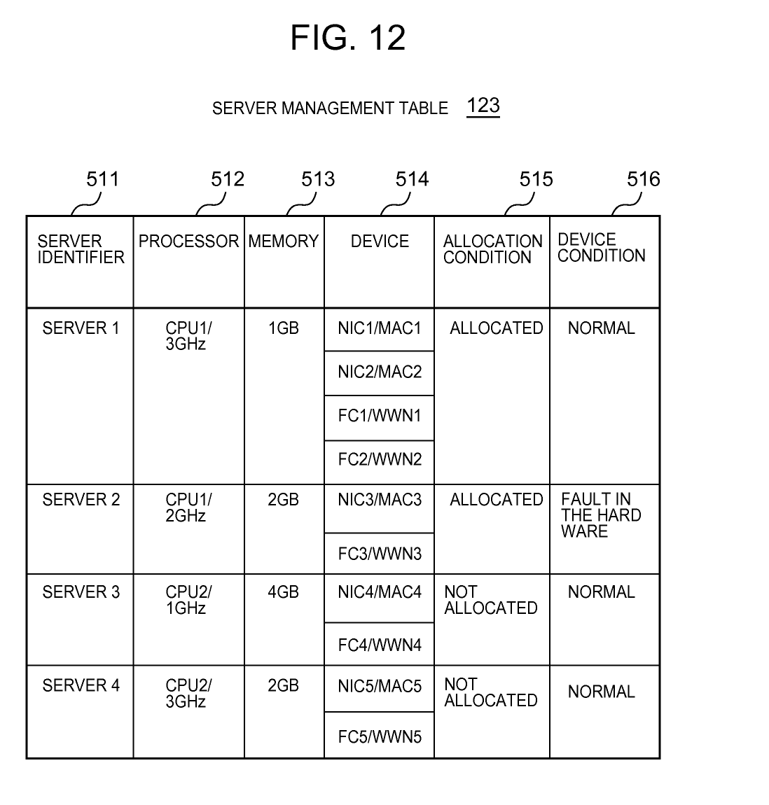

FIG. 12 shows a structural example of the server management table.

The server management table 123 comprises a column 511 in which a server identifier (for example, a name) is written, columns 512 and 513 in which information relating to a server resource is written, a column 514 in which information relating to a device (for example, the type of communication interface device) is written, a column 515 in which an allocation condition is written, and a column 516 in which a device condition is written. A server identifier, information relating to a server resource, an allocation condition and a device condition are written for each server. Note that the information relating to a server resource is for example, information relating to a processor (for example, the type of processor and the clock frequency) and information relating to memory (for example, the storage capacity of the memory). The allocation condition is for example, relates to whether the server in question is already being used to execute a job as an original server or as a clone server. There are two types of allocation conditions, one in which the server is already allocated, and the other in which the server is not allocated. The allocation condition is updated to “allocated” when the server in question is selected by the system multiplexing program 117, and is updated to “not allocated” when the server in question is not longer selected as a clone server. The device condition is for example, a condition relating to the operation of the server, and device conditions are, for example, normal, and that a fault has occurred, in which case the type of fault that occurred. A server is one that can be assigned as a clone server when its device condition is normal.

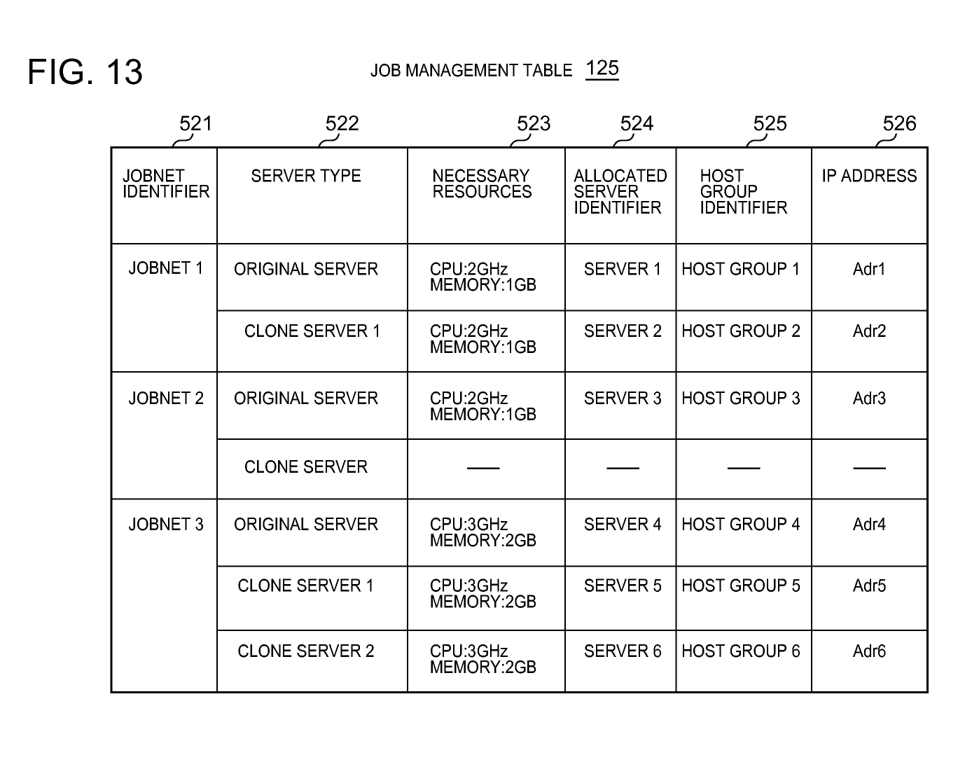

FIG. 13 shows a structural example of the job management table 125.

The job management table 125 comprises a column 521 in which a jobnet identifier (for example, a name) is written, and columns in which information relating to the servers that will execute the jobnet. The jobnet identifier and information relating to one or more servers is written for each jobnet.

The columns in which information relating to the servers is written comprise a column 522 in which the type of server (original or clone) is written, a column 523 in which the necessary resources (for example, the type of CPU, the clock speed and the memory capacity) for executing the jobnet are written, a column 524 in which an allocated server identifier is written, a column 525 in which a host group identifier is written, and a column 526 in which an IP address is written. A server type, the necessary resources, the allocated server resources, the host group identifier, and the IP address are written for each server. Note that the server type indicates whether the jobnet will be executed with the server acting as an original server or with the server acting as a clone server. The allocated server identifier is an identifier for a server allocated as a respective server type. The host group identifier is an identifier for the host group to which the server in question belongs. The IP address is one that is allocated to the server in question.

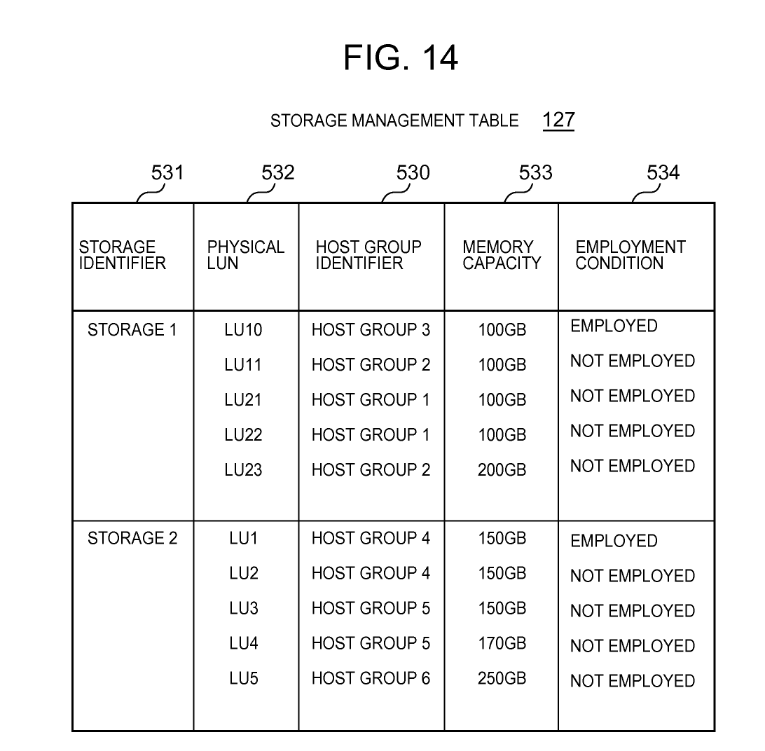

FIG. 14 is a structural example of the storage management table 127.

The storage management table 127 comprises a column 531 in which a storage system identifier (for example, a name) is written, a column 532 in which a physical LUN of a physical LU comprising the storage system is written, a column 530 in which an identifier for the host group to which the physical LU belongs is written, a column 533 in which the storage capacity of the physical LU is written, and a column 534 in which the employment condition (for example, “employed” or “not employed”) of the physical LU is written. This storage management table 127 is used to manage empty physical LUs in the storage system 109.

More specifically, for example, the employment condition of the physical LU in the copy destination is updated to “employed” when the copy operation is completed between the physical LUs, and the employment condition of the physical LU is updated to “not employed” when the clone server allocated to the physical LU is released. The data in the physical LU is erased when the physical LU is updated to “not employed”.

The above description is an explanation of the various types of information maintained in the management server 101. Next, an explanation will be given of one example of the flow of the processing performed in the present embodiment.

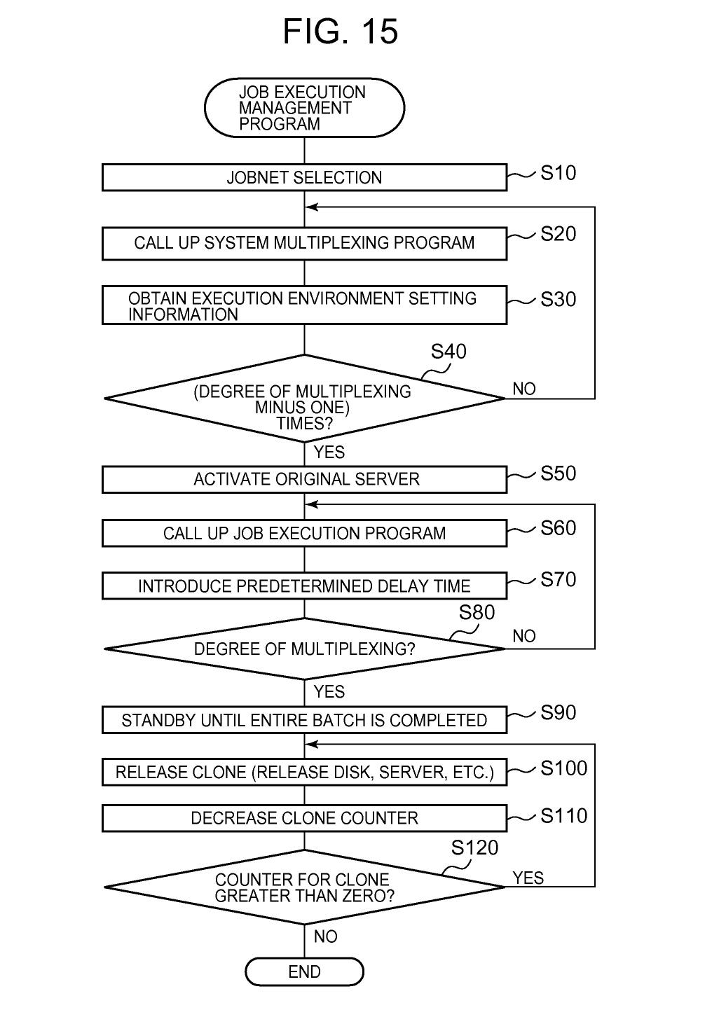

FIG. 15 shows an example of the flow of the processing performed by the job execution management program 113.

The job execution program 113 selects a jobnet corresponding to batch processing (step S10). More specifically, for example, the job execution management program 113 selects a jobnet in which the execution start time has arrived as the one to perform batch processing by referring to the job definition table 121. The selected jobnet will be referred to as jobnet 1 below.

Also when the job execution management program 113 selects the jobnet 1, the job execution management program 113 specifies the resources needed for the original server to execute the jobnet 1, from the job management table 125, and specifies a server not yet allocated, from the server management table 123, that has the specified necessary resources. The job execution management program 113 writes the specified server identifier in the column corresponding to “jobnet 1” and “original server” in the job management table 125. Note that the necessary resources include software resources as well as hardware resources, and necessary resources may include whether the server has the necessary computer program to execute the jobnet 1. In the case in which the software resource is available, it may be that the software is already installed in the server, or it may be that the software is not installed but can be obtained from an outside logical volume.

The original server for the jobnet 1 will be referred to as “original server 1” or simply as “server 1” below. The clone server will be referred to as “clone server 2” or simply as “server 2” below.

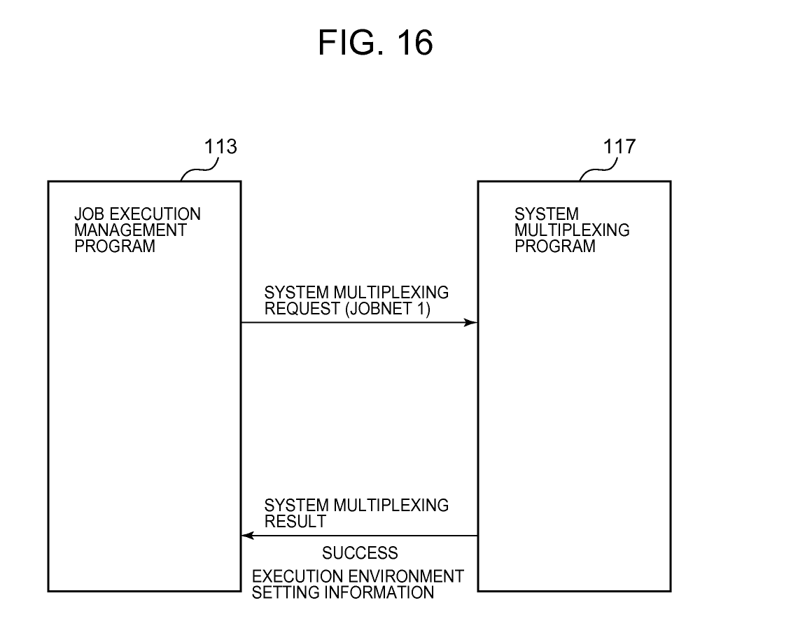

Next, the job execution management program 113 specifies the degree of multiplexing corresponding to the jobnet 1 from the job definition table 121, and if the specified degree of multiplexing is one or more, calls up the job multiplexing program 117 (if the specified degree of multiplexing is zero then the job execution management program 113 proceeds to S50) (S20). The degree of multiplexing corresponding to the jobnet 1 is “1” according to the job definition table 121 shown by example in FIG. 11, thus S20 will be performed. In S20, for example, the job execution management program 113 transmits a system multiplexing request and the identifier “jobnet 1” for the jobnet 1, as shown in FIG. 16. In this manner, the system multiplexing program 117 performs system multiplexing and as a result, as shown in FIG. 16, a response is sent from the system multiplexing program 117 to the job execution management program 113.

The job execution management program 113 obtains execution environment setting information when the system multiplexing is successful (S30). The execution environment setting information indicates the execution environment set in the clone server 2 and more specifically is, for example, the IP address of the clone server 2.

S20 and S30 are repeated the number of times as the degree of multiplexing minus one. More specifically, the job execution management program 113 determines whether S20 and S30 have been repeated only the same number of times as the degree of multiplexing corresponding to the jobnet 1 minus one, and if they have not been repeated (NO in S40), then the job execution management program 113 performs S20 again. Here the degree of multiplexing corresponding to the jobnet 1 is “1”, and 1−1=0, thus S20 and S30 are not repeated.

When the repeating of S20 and S30 is ended (YES in S40), the job execution program 113 activates the selected original server 1 described above (S50).

Next, the job execution management program 113 calls up the job execution program 119 (S60). At this time, notification of the identifier of the server 105 is made to the job execution program 119.

Then the job execution management program 113 waits for a fixed length of time (S70), and determines whether S60 and S70 have been repeated the number of times that corresponds to the degree of multiplexing (S80). The job execution management program 113 performs S60 again when S60 and S70 have not been repeated the number of times that corresponds to the degree of multiplexing (NO in S80).

When S60 and S70 have been repeated the number of times that corresponds to the degree of multiplexing (YES in S80), the job execution management program 113 waits until the jobnet 1 is ended in servers 1 and 2, which execute jobnet 1 (S90).

When the jobnet 1 is completed in all of the servers 1 and 2, the job execution management program 113, if the clone counter to be described below is one or more, refers to the job management table 125, and releases the clone server 2 when a clone server 2 has been detected in the jobnet 1 (if the clone counter to be described below is “0” then this step is ended) (S100). More specifically, for example, as shown in FIG. 13, the job execution management program 113 removes information related to the server 2 (“server 2”, “host group 2” and “adr 2”) from the job management table 125 and updates the allocation condition (the allocation condition shown by example in FIG. 12) of the server 2 to “not allocated”, when a server is allocated as a clone server.

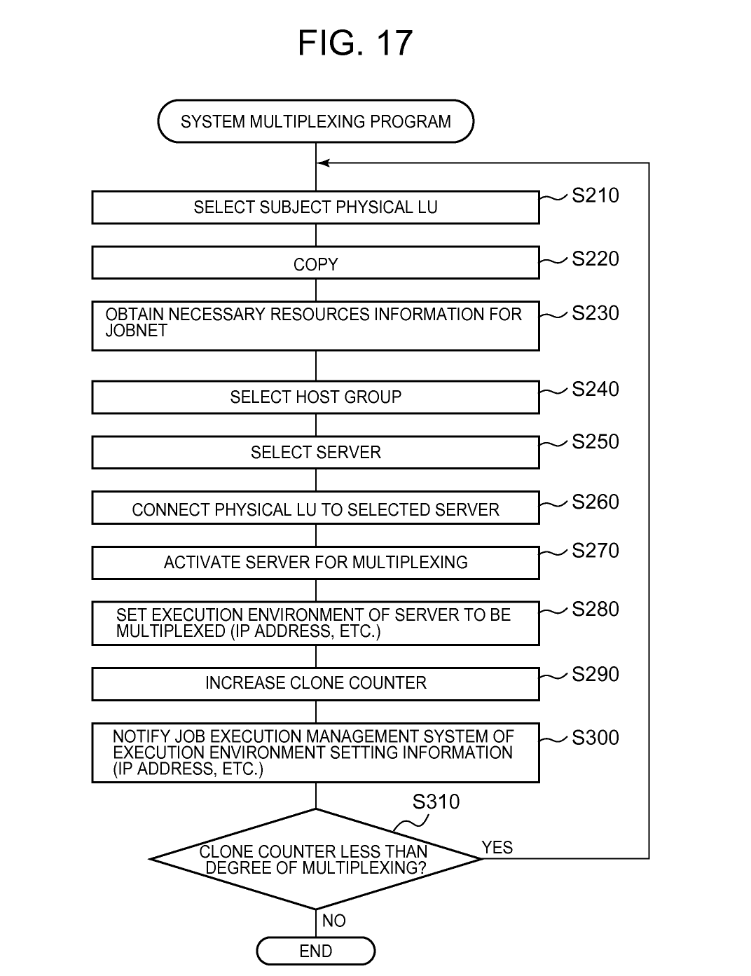

The job execution management program 113, when it releases the clone server 2, reduces the clone counter by one (S110). The clone counter is a value indicating the number of clone servers, this value is added when a clone server is generated in the processing shown by example in FIG. 17.

The job execution management program 113 executes S100 again when the clone counter has not reached zero (NO in S120), and ends when the clone counter has reached zero.

FIG. 17 shows an example of the processing performed by the system multiplexing program 117, which is called up by the job execution management program 113.

The system multiplexing program 117 refers to the storage management table 127 and selects a physical LU which has an employment condition of “not employed” (S210). At that time the system multiplexing program 117 specifies a host group 1, to which the original server 1 belongs, from the job management table 125, specifies a physical LU and the memory capacity thereof, which belongs to the specified host group 1, from the storage management table 127, and selects a “not employed” physical LU having the specified memory capacity or more. Here, one “not employed” physical LU is selected for each physical LU.

The system multiplexing program 117 causes the control program 219 to copy data from the physical LU belonging to the host group 1 to the selected physical LU (S220). In this manner, data copying is performed from all of the physical LUs belonging to the host group 1 (system physical LUs and data physical LUs) to all of the selected physical LUs, respectively.

Next. The system multiplexing program 117 selects a host group (S240). Also, the system multiplexing program 117 refers to the server management table 123 to select a “not employed” server 105 with the necessary resources for the jobnet 1 (S250). Then the system multiplexing program 117 connects the physical LU selected in S210 to the selected server 105 (S260). More specifically, for example, the system multiplexing program 117 inputs, using a set-mapping command, all the LUNs of the physical LUs selected in S210, all the LUNs of the virtual LUs that are associated with the physical LUs, the identifier of the server 105 selected in S250, and the identifier of the host group selected in S240. In this manner, the input information is recorded in disk mapping table 220 maintained by the control program 219.

The system multiplexing program 117 activates the server 105 (also referred to as the multiplexing server 105 below) selected in S250 (S270). In this manner, the multiplexing server 105 (in other words, the clone server 2) reads the server environment from, among the connected one or more physical LUs, the system physical LU, and sets the execution environment of the multiplexing server 105.

The system multiplexing program 117 sets the execution environment of the multiplexing server 105 (S280). More specifically, the system multiplexing program 117 sets an execution environment in the multiplexing server 105 that differs from the execution environment set when the server environment is read. This is done so that the execution environment of the multiplexing server 105 is not the same as the execution environment (for example, the IP address) of the original server, which is activated in S50 of FIG. 15.

The system multiplexing program 117 increases the clone counter by one (S290).

Also, the system multiplexing program 117 gives notification to the job execution management program 113 of the execution environment set in S280 and the identifier of the multiplexing server 105 in which the execution environment has been set (S300).

The system multiplexing program 117 determines whether the clone counter updated in S290 is less than the degree of multiplexing specified by the job execution management program 113, and when the clone counter is less than the degree of multiplexing (YES in S310), the system multiplexing program 117 executes S210 again, and when the clone counter is the same as the degree of multiplexing (NO in S310) the system multiplexing program 117 ends the process.

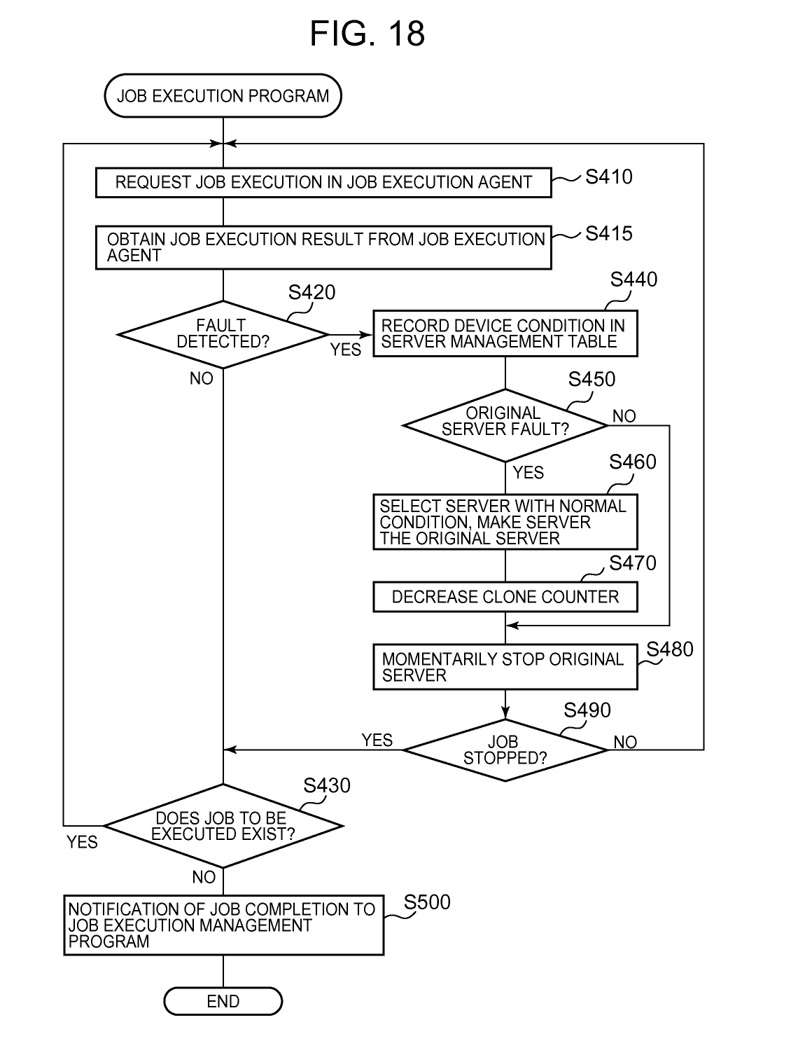

FIG. 18 shows an example of the processing performed by the job execution program 119, which is called up by the job execution management program 113.

The job execution program 119 specifies a server 105 that corresponds to the server identifier notified by the job execution management program 113, and makes a request to the job execution agent 143 in the specified server 105 for the job execution agent 143 to execute a job (S410). At that time, the job execution program 119 notifies the job execution agent 143 of the job name of the job to be executed, and the program name (the job name and the program name specified in the job definition table 121).

Then the job execution program 119 receives the execution result of the job (S415).

When there is no fault indicated in the execution result (NO in S420), and if there is a job to be performed in the jobnet 1 (YES in S430), the job execution program 119 performs S410 to execute that job. Note that the timing in which S410 is executed is set on the basis of the job definition table 121. More specifically, for example, when S410 is performed for job 1 in the jobnet 1, in the case in which the job execution program 119 receives a response from the job execution agent 143 that job 1 has been ended, S410 is performed for jobs 2 and 3.

When the received execution result indicates a fault (YES in S420), the job execution program 119 updates the device condition (the device condition recorded in the server management table 123) that corresponds to the server identifier of the server that is the request destination (the server 105) of S410 (S440). Here, when the server type of the server corresponding to the updated device condition is an original server (YES in S450), the job execution program 119 arbitrarily selects a clone server, from among the clone servers corresponding to the jobnet 1, which has a normal device condition, and temporarily sets this clone server as the original server (S460).

The job execution program 119 reduces the clone counter by one (S470) since the number of servers 105 available to execute the jobnet 1 decreased by one.

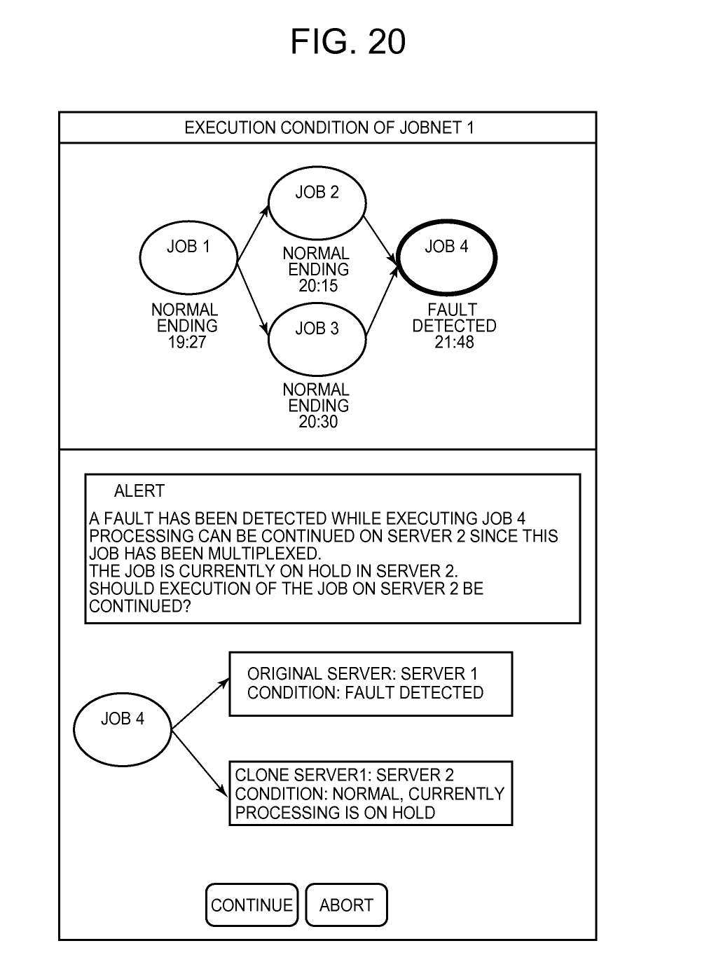

The job execution program 119 temporarily stops the original server (S480), produces a GUI, which indicates the execution condition of the jobnet 1 (referred to as the execution condition GUI below), and displays the produced execution condition GUI to the administrator. The execution condition GUI indicates information relating to how many servers are executing the jobnet 1 and in which server among these servers and in which job among the jobnet 1, a fault has been detected, and information relating to the possibility of executing that job on another server. FIG. 20 shows an example of this execution condition GUI. This execution condition GUI is displayed after jobs 1, 2, and 3 have been completed normally in all the servers 1 and 2, and after the sever 2 has been changed from a clone server to an original server because a fault occurred in the server 1 when executing job 4 (however, the display shows which servers are the clone server and the original server prior to the change, so as not to confuse the administrator). The job execution program 119 can record the job execution completion time for each job and display these times in the GUI. These times, and whether there is a normal completion of a job, or whether there is a fault, are displayed along with a structural diagram of the jobnet 1. The structural diagram of the jobnet 1 can be constructed on the basis of the job information in the job definition table 121 (in particular, for example, information shown in columns 504 and 505, and column 507).

Also the possibility of executing job 4, which has been stopped in the server 1, on the server 2 is shown (however, presently execution is temporarily stopped). That job 4 is temporarily stopped in server 2 can be specified from that the server 2 has been set to the original server and in S480 has been temporarily stopped, and from that the execution result for job 4 has not been received by the job execution agent 143 of the server 2.

Also in this execution condition GUI there is a “continue” button and an “abort” button. When the “continue” button is pressed, job 4 is continued on the server 2 (in other words, the batch processing is continued), and when the “abort” button is pressed, the execution of job 4 is stopped (in other words, the batch processing is stopped). The administrator sees this execution condition GUI and determines whether to continue or to abort the execution of job 4. Note that in this example, the server 2 is made the original server, thus the server 2 is temporarily stopped, however, the execution of job 4 may be continued on another server by temporarily stopping only the server 2, in the case in which, in addition to the server 2, there are other clone servers.

When abort or continue has been selected, the job execution program 119 updates the job management table 125 in order to set the temporary original server to the actual original server. More specifically, for example, the server identifier that corresponds to the original server is changed from the server 1 to the server 2.

When job abort is selected (YES in S490), the job execution program 119 notifies the request source (job execution management program 113) that the job is ended (S500). When continuation of the job is selected (NO in S490), the job execution program 119 executes S410.

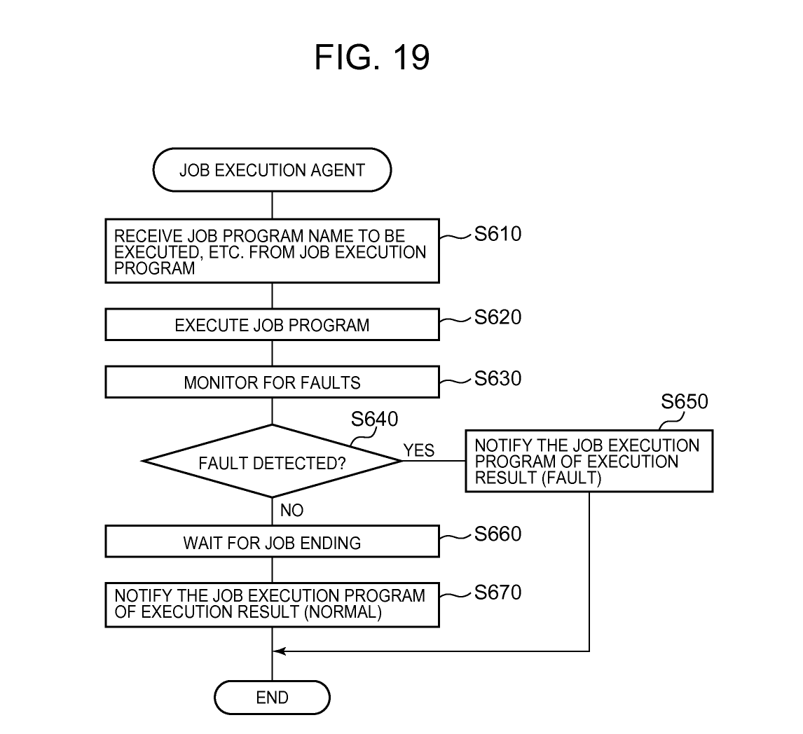

FIG. 19 shows an example of the processing performed by the job execution agent 143.

The job execution agent 143 receives the job execution request, the job name and the program name (S610), and in response to the job execution request, executes the job corresponding to the job name of which notification has been received, with the job program 145 corresponding to the program name of which notification has been received (S620).

The job execution agent 143 monitors whether a fault occurs in the execution of the job (S630). When the result is that a fault is detected (YES in S640), the job execution agent 143 notifies the job execution program 119 of the fault that resulted in the execution. On the other hand, when no fault is detected and a job completion response is received (NO in S640, S660), the job execution agent 143 notifies the job execution program 119 of an execution result of normal ending.

In the embodiment described above, when executing a jobnet for performing batch processing, a server 105 having the necessary resources to perform the execution is dynamically selected as the clone server, and the jobnet is executed by both the original and clone servers. Special hardware is not needed in this embodiment due to the employment of multiplexing. In this manner, a low cost openserver system is realized having high reliability to the extent that batch processing can be performed. Also, in this embodiment not all of the servers in the system are shown to the system administrator in advance, only the dynamically selected servers to be multiplexed from among all the servers are shown, thus confusion is avoided in operating the system. More specifically, in the present embodiment, a clone server is dynamically generated just by defining the necessary resources, and it is not necessary to define a clone server to correspond to the original server in advance.

Additionally, in the embodiment described above, the necessary execution environment for performing the batch processing can be obtained and thus the clone environment can be constructed when generating a clone server. More specifically, the size and type of necessary resources for executing batch processing, contained in the original server, setting information for the storage system, and setting information for the network are matched to the batch processing execution environment, thus the necessary resources for constructing a clone server are obtained in advance and accurately. When performing processing by obtaining the above information without using the present invention, management software or the like for a server is used to obtain server information, operating system information and the like, management software or the like for a storage system is used to inquire about the connections between the servers and the storage system, to update the settings of the storage devices, and the like. Complicated related information is thus obtained using a plurality of management software, and performing accurate changes in the settings is necessary, types of problems the present embodiment avoids.

An embodiment of the present invention has been explained above, however, the embodiment is no more that an example to explain the present invention, and does not have a purpose of limiting the scope of the present invention to only the embodiment. The present invention can be carried out in various other forms that do not deviate from the basic points of the present invention. For example, instead of producing and displaying an execution condition GUI when a fault is detected (in other words, continuing the job on another server instead of making an inquiry to the administrator), the execution condition GUI may also be produced only when a condition arises that is recorded in advance in the management server 101 (for example, the number of servers remaining among the multiplexed servers is N (N is an integer)). Also, for example, at least one portion of at least one computer program of the previously described various computer programs (for example, the job execution program 113, the system multiplexing program 117, and the like) may be realized using hardware (for example, specialized hardware such as ASIC (Application Specific Integrated Circuit)).

The present application offers a low cost server system that is reliable for batch processing and that is not complicated to operate.

What is claimed is:

1. A management server for a server system comprising a plurality of servers and the management server for managing the plurality of servers, the management server further comprising:
a second server selection unit for selecting, when a jobnet which is formed from one or more jobs for batch processing is executed, a second server that is not allocated from among the plurality of servers including a first server that executes the jobnet;
a server environment setting unit for setting a server environment, in the selected second server, which is a server environment in the first server;
a jobnet execution unit for executing each job that forms the jobnet in the first server and the second server in which the server environment has been set respectively; and
a server release unit for releasing the second server when execution end notification for the jobnet is received from the first and second servers respectively.

2. The management server according to claim 1, further comprising:
a server management storage unit for storing server management information including information relating to each server resource and to an allocation condition of each server; and
a job definition storage unit for storing job definition information including information relating to resources necessary for executing the jobnet, wherein
the second server selection unit selects a server that is not allocated and that has the resources necessary for executing the jobnet, by referring to the server management information and the job definition information.

3. The management server according to claim 2, wherein
the job definition information includes a degree of multiplexing for the jobnet, and the second server selection unit selects the same number of servers to be second servers as the degree of multiplexing.

4. The management server according to claim 1, wherein
the first and the second servers are not activated when the server environment is set, and the server environment includes an execution environment for the jobnet, and
the server environment setting unit activates the second server and then sets an execution environment, in the second server, which differs from an execution environment which has been set in the second server, this execution environment being the same as an execution environment in the first server, after which the server environment setting unit activates the first server.

5. The management server according to claim 4, wherein
the plurality of servers and the management server are connected to a communication network having Internet protocol, and
the execution environment is an IP address.

6. The management server according to claim 4, wherein
the storage system connected to the plurality of servers and to the management server to allow communication is included in the server system,
the storage system comprises a plurality of storage devices and a controller, and the plurality of storage devices include a first storage device for storing the server environment of the first server, and
the server setting environment unit causes the controller to copy the server environment in the first storage device to another storage device among the plurality of storage devices, connects the other storage device to the second server, activates the second server after the copy operation is completed, and thus induce the second server to read the server environment from the other storage device.

7. The management server according to claim 1, wherein the jobnet execution unit continues to execute the jobnet, with the second server acting in place of the first server, when the jobnet execution unit receives notification of a fault from a first server in which a failure is detected when a requested job is executed.

8. The management server according to claim 1, further comprising a job definition storage unit for storing job definition information which includes information relating to a structure of the jobnet, wherein
the jobnet execution unit receives a normal ending notification for a job from a server which is a request destination of the job, discerns that the job has ended normally from the normal ending notification, and in the case that the jobnet execution unit receives a failure notification, from a server which is a request destination of a job, that a failure has been detected while executing the job on the basis of whether the jobnet execution unit has received normal ending notification from another server which is a request destination of the job and on the basis the job definition information, the jobnet execution unit produces and displays a GUI inquiry, to an administrator, which shows that a failure is detected in the server from which the failure notification has been sent and the condition of the processing of the job in the other server which is a request destination of the job in accompany with the jobnet structure, and which inquires as to whether to continue or abort the job, and when the administrator chooses to continue, the jobnet execution unit continues the job.

9. The management server according to claim 1, wherein
the first server is set as an original server, and
the second server is set as a clone server of the original server.

10. A server system comprising:
a plurality of servers; and
a management server for managing the plurality of servers, wherein
the management server comprises:
a second server selection unit for selecting, when a jobnet which is formed from one or more jobs for batch processing is executed, a second server that is not allocated from among the plurality of servers including a first server that executes the jobnet;
a server environment setting unit for setting a server environment, in the selected second server, which is a server environment in the first server;
a jobnet execution unit for executing each job that forms the jobnet in the first server and the second server in which the server environment has been set respectively; and
a server release unit for releasing the second server when execution end notification for the jobnet is received from the first and second servers respectively.

11. A job execution method for realizing a server system having a plurality of servers, comprising the steps of:
selecting, when a jobnet which is formed from one or more jobs for batch processing is executed, a second server that is not allocated from among the plurality of servers including a first server that executes the jobnet;
setting a server environment, in the selected second server, which is a server environment in the first server;
executing each job that forms the jobnet by the first server and by the second server in which the server environment has been set respectively; and
releasing the second server when execution end notification for the jobnet is received from the first and second servers respectively.

12. The management server according to claim 1, further comprising a job definition storage unit for storing job definition information including information relating to a structure of the jobnet, and further comprising
means for outputting a screen on the basis of the job definition information for a user to select whether to continue or abort a job when a failure notification indicating that a failure is detected when the job is executed is received, and for receiving from the user an instruction to continue or to abort, wherein
the jobnet execution unit receives a normal ending notification for a job from a server which is a request destination of the job, discerns that the job has ended normally from the normal ending notification, and in the case that the jobnet execution unit receives a failure notification, from a server which is a request destination of a job, that a failure has been detected while executing the job, on the basis of whether the jobnet execution unit received normal ending notification from another server which is a request destination of the job and on the basis the job definition information, determines whether to continue the job.
